(19) United States
(12) Patent Application Publication
(10) Pub. No.: US 2011/0269645 A1
(43) Pub. Date: Nov. 3, 2011

(54) Cell chip, method of manufacturing the same and device for manufacturing cell chip

(75) Inventors: Se Hoon Jeong, Seoul (KR); Sang Jin Kim, Suwon (KR); Bo Sung Ku, Suwon (KR)

(73) Assignee: SAMSUNG ELECTRO-MECHANICS CO., LTD., Suwon (KR)

(21) Appl. No.: 12/923,096

(22) Filed: Sep. 1, 2010

(30) Foreign Application Priority Data
May 3, 2010 (KR) 10-2010-0041554

(51) Int. Cl. C40B 40/02; C40B 60/08; C40B 50/06; C40B 60/14

(52) U.S. Cl. 506/14; 506/40; 506/37; 506/26

(57) ABSTRACT

Provided is a cell chip, a method of manufacturing the same, and a device for manufacturing the same. The cell chip includes a substrate on which a plurality of cell fixing materials having a predetermined area are arranged, a plurality of single cells fixed by the plurality of cell fixing materials, respectively, and a plurality of cell scattering materials formed of a porous material and provided in the form of droplets combined with the plurality of cell fixing materials and surrounding the single cells, respectively. The device for manufacturing the cell chip includes a first inkjet head discharging a cell fixing material having a predetermined area onto a substrate, and a second inkjet head including an internal channel having one or more curved portions, and discharging a plurality of cells, contained in a cell scattering material passing through the internal channel, individually to the cell fixing material.

### CROSS-REFERENCE TO RELATED APPLICATIONS

This application claims the priority of Korean Patent Application No. 10-2010-0041554 filed on May 3, 2010, in the Korean Intellectual Property Office, the disclosure of which is incorporated herein by reference.

### BACKGROUND OF THE INVENTION

1. Field of the Invention

The present invention relates to a cell chip, a method of manufacturing the same and a device for manufacturing a cell chip, and more particularly, to a cell chip, including single cells arranged therein and being capable of quick and accurate diagnosis, a method of manufacturing the same, and a device for manufacturing the same.

2. Description of the Related Art

Of late, studies of human life, led by the human genome project, have made rapid progress. Advances in research into living organisms are leading to the rise of technologies which are able to quickly analyze and process more information regarding living organisms, and are heightening attention toward biochips capable of performing a quick analysis of information regarding organisms.

Biochips may be categorized into DNA chips, protein chips and cell chips according to the kind of bio material fixed to a substrate. At the initial stage of biochip development, DNA chips were highlighted in line with the understanding of human genetic information. However, protein chips and cell chips are currently at the center of attention due to increasing interest in proteins, serving as the basis of metabolism, and cells, the mainstay of organisms.

Protein chips, in their initial stage, may suffer non-selective attachment which is difficult to solve; however several noticeable improvements have recently emerged.

Cell chips are currently drawing great attention as an effective medium that is accessible to a variety of fields such as the development of new medicines, genomics, proteomics and the like. It is important to fix cells to cell chips without changing the properties thereof.

A cell analysis is facilitated when a cell is fixed to a substrate to grow and divide thereon. In this case, it can be easily observed how a cell reacts to a new medicine or another bodily material, for example. However, there are several issues to overcome in developing such cell chips, such as the fixation of a large amount of cells, cell aggregation during cell fixation, and the maintenance of cell organization.

A plurality of known methods of fixing cells to a substrate are present, and may be divided into a fixing method using biomaterials and a fixing method using the physical and chemical characteristics of a substrate.

As for one example of the fixing method using a bio material, a peptide or a protein is initially fixed on a substrate, and a cell is then fixed to the substrate by using a cell receptor having those bio materials.

As for one example of the fixing method using physical and chemical characteristics of a substrate, the hydrophobic property, electrical property or surface structure of a substrate may be used.

However, cell chips have limitations in that it is difficult to fix cells to a substrate. The uneven fixation of cells may cause cell aggregation and make it difficult to maintain cell organization. A cell chip, ensuring successful fixation, may allow a small amount of cells to be fixed, thereby enhancing the sensitivity of the cell chip.

Furthermore, it is important to maintain the properties of cells at the time of fixing cells to a substrate. A cell chip may not function properly when cells, even if properly fixed to a substrate, fail to grow well and lose their inherent properties due to the properties of the substrate.

### SUMMARY OF THE INVENTION

An aspect of the present invention provides a cell chip capable of quick and accurate diagnosis, a method of manufacturing the same, and a device for manufacturing a cell chip.

According to an aspect of the present invention, there is provided a cell chip including: a substrate on which a plurality of cell fixing materials having a predetermined area are arranged; a plurality of single cells fixed by the plurality of cell fixing materials, respectively; and a plurality of cell scattering materials formed of a porous material and provided in the form of droplets combined with the plurality of cell fixing materials and surrounding the single cells, respectively.

The cell fixing materials may include at least one selected from the group consisting of polyethylene imine, polylysine, polyvinylamine, polyarylamine, fibronectin, gelatine, collagen, elastin and laminine.

The cell fixing materials may include a gelation material allowing for the gelation of the cell scattering materials.

The cell fixing materials may include at least one gelation material selected from the group consisting of BaCl₂, palladium acetate, N,N′-Bis(salicylidene)pentamethylenediamine and potassium phosphate.

The substrate maybe coated with a hydrophobic material.

The cell scattering materials may be provided in the form of sol-gel, hydrogel, alginate gel, organogel or xerogel.

According to another aspect of the present invention, there is provided a device for manufacturing a cell chip, the device including: a first inkjet head discharging a cell fixing material having a predetermined area onto a substrate; and a second inkjet head including an internal channel having one or more curved portions, and discharging a plurality of cells, contained in a cell scattering material passing through the internal channel, as single cells to the cell fixing material.

The curved portions may each be curved at a predetermined angle with respect to a main passage of the internal channel.

The curved portion formed toward an outlet of the internal channel may have a length different from that of another curved portion formed toward an inlet of the internal channel.

The internal channel may have a polygonal or circular sectional shape.

The internal channel may include a single cell detection module provided at an outlet thereof and including a light source emitting light to a cell passing a specific location, and a detector detecting a signal change of light passing through the cell.

According to another aspect of the present invention, there is provided a device for manufacturing a cell chip, the device including: a first inkjet head discharging a cell fixing material having a predetermined area onto a substrate; and a second inkjet head including an internal channel having one or more curved portions, and discharging a single cell to the cell fixing material, wherein the internal channel has a sectional area smaller toward an outlet thereof than that toward an inlet thereof, and serve to separate a plurality of cells, included in a cell scattering material passing through the internal channel, into single cells.

The internal channel may include a single cell detection module provided at the outlet thereof and including a light source emitting light to a cell passing a specific location, and a detector detecting a signal change of light passing through the cell.

According to another aspect of the present invention, there is provided a method of manufacturing a cell chip, the method including: discharging, by a first inkjet head, a cell fixing material having a predetermined area on a substrate; passing a cell scattering material including a plurality of cells through an internal channel having a curved portion to thereby separate the plurality of cells into single cells; and discharging the cell scattering material and each of the single cells in the form of a droplet to the cell fixing material.

The cell fixing material may include a gelation material allowing for the gelation of the cell scattering material.

The separating of the plurality of cells into single cells may include: emitting light to a cell passing a specific location of the internal channel; and adjusting the number of cells by detecting a signal change of light passing through the cell.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating a cell chip according to an exemplary embodiment of the present invention;

FIG. 2 is a conceptual view for describing a device for manufacturing a cell chip according to an exemplary embodiment of the present invention; and

FIGS. 3A through 3C are schematic conceptual views illustrating an internal channel of an inkjet head.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity. Like reference numerals in the drawings denote like elements.

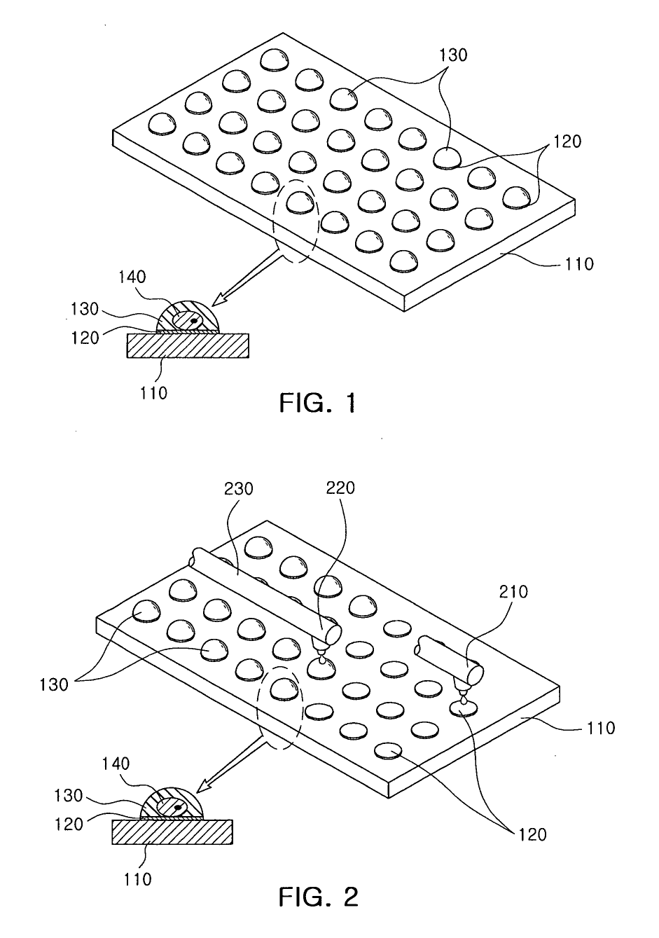

FIG. 1 is a schematic perspective view illustrating a cell chip according to an exemplary embodiment of the present invention.

Referring to FIG. 1, a cell chip according to an exemplary embodiment of the present invention includes a substrate 110, cell fixing materials 120, single cells 140, and cell scattering materials 130. According to this exemplary embodiment, the cells 140 are arranged in a matrix configuration on the substrate 110.

A material of the substrate 110 adopted for the present invention is not specifically limited, provided that the surface thereof can be modified by a cell fixing material. For example, the substrate 110 may be formed of silicon, glass, metal or polymer.

The polymer substrate, although not limited to the following material, maybe formed of poly (methyl methacrylate) (PMMA), polycarbonate (PC), polystyrene (PS), polypropylene, cyclic olefin copolymer, polynorbonene, styrenic block copolymer (SBC), or acrylonitrile butadiene styrene.

The substrate 110 may be coated with a hydrophobic material as the occasion arises. The hydrophobic material, although not limited thereto, may utilize poly styrene-co-maleic anhydride (PSMA), methyltrimethoxysilane (MTMOS) or the like.

A plurality of cell fixing materials 120 having a predetermined area are arranged on the substrate 110. The surface of the substrate 110 is modified by the cell fixing materials 120 to thereby fix cells. According to this exemplary embodiment, the cell fixing materials 120 are arranged at specific locations, not on the entirety of the substrate 110. This arrangement may be achieved by using an inkjet method.

The size of each area of the cell fixing material 120 is not limited specifically. The cell fixing materials 120 may have a size allowing for the fixation of the single cells 140.

The single cells 140 are respectively fixed to the substrate 110 by the cell fixing materials 120, and are surrounded by the cell scattering materials 130.

The kind of cell is not limited. For example, the single cell may be a microorganism, an animal or plant cell, a cancer cell, a nerve cell, an intravascular cell, an immunocyte, or the like. Furthermore, DNA, RNA, olligo, enzyme, medicine or a mixture thereof maybe fixed by the cell fixing materials 120.

The cell fixing materials 120, although not limited thereto, may utilize, for example, polyethylene imine, polylysine, polyvinylamine, polyarylamine, fibronectin, gelatine, collagen, elastin, laminine, or a mixture thereof.

Furthermore, the cell fixing materials 120 may include a gelation material that makes the cell scattering material 130 into a gel.

The gelation material, although not limited thereto, may utilize BaCl₂, palladium acetate, N,N′-Bis (salicylidene) pentamethylenediamine, potassium phosphate, or a mixture thereof.

According to this exemplary embodiment, the cell scattering material 130 is in the form of droplets. A single cell 140 is present at the center of a droplet. The droplet including the single cell 140 may be formed by an inkjet method.

The cell scattering materials 130 may be a porous material. The cell scattering material 130 is combined with the cell fixing material 120 and surrounds the single cell 140. The cell fixing material 120 may be in a gelated form.

The cell scattering material 130 may contribute to more firmly fixing the single cell 140 to the substrate 110. Furthermore, the cell scattering material 130 allows the single cell 140 to maintain its organization and its functions.

The material of the cell scattering material 130 is not specifically limited, provided that the cell scattering material 130 allows for the maintenance of cell functions.

Furthermore, the cell scattering material 130, the porous material, may allow for the transmission of cell culture solutions, specific medicines, various aqueous solutions or the like.

The cell scattering material 130, although not limited thereto, may be in the form of sol-gel, hydrogel, alginate gel, organogel or xerogel.

According to this exemplary embodiment, cells are patterned at regular intervals in the cell chip, thereby achieving an increase in chip density. That is, a greater amount of cell samples are fixed within a cell chip having the same area. Accordingly, different diagnoses may be conducted on the same kind of cells at the same time, and the accuracy of experimental results can be improved.

Furthermore, various kinds of cells may be fixed to be tested on their properties responding to the same medicine or to be diagnosed at the same time.

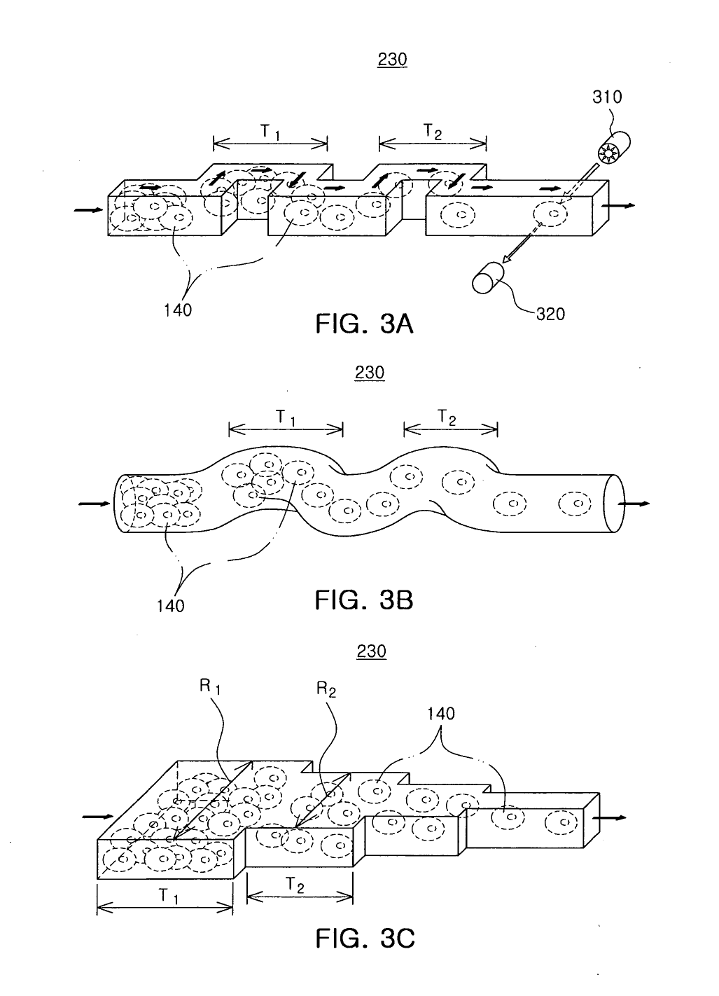

FIG. 2 is a conceptual view illustrating a device for manufacturing a cell chip according to an exemplary embodiment of the present invention. FIGS. 3A through 3C are schematic conceptual views illustrating the internal channel of an inkjet head.

Referring to FIGS. 2 and 3A, the device for manufacturing a cell chip, according to an exemplary embodiment of the present invention, includes a first inkjet head 210 and a second inkjet head 220.

The first inkjet head 210 discharges the cell fixing material 120 having a predetermined area onto the substrate 110. Accordingly, the cell fixing materials 120 may be arranged on the substrate 110 at regular intervals.

Thereafter, the second inkjet head 220 discharges single cells 140 onto the cell fixing material 120. The second inkjet head 220 is provided with an internal channel 230 having one or more curved portions. The cell scattering material 130, containing a plurality of cells, is injected into the internal channel 230. The internal channel 230 includes curved portions T1 and T2.

In general, it is difficult to separate cells individually. Thus, cells in the cell scattering material 130 are present in the form of a mass. The curved portions T1 and T2 interrupt the flow of the cell scattering materials 130. Accordingly, the plurality of cells in the mass form may be divided into individual single cells. The cell mass having passed through the internal channel 230 is discharged onto the substrate 110 as single cells.

The curved portions T1 and T2 are curved at a predetermined angle with respect to the main passage of the internal channel 230. The angle of the curved portions T1 and T2 is not specifically limited.

As in this exemplary embodiment, the curved portions T1 and T2 may be bent to an angle of 90 degrees with respect to the main passage of the internal channel 230. However, the present invention is not limited thereto, and the curved portions T1 and T2 may be bent to an angle of 30 degrees, 60 degrees, 120 degrees or 150 degrees within an angular range between 0 degrees and 180 degrees.

The curved portion T2, formed near the outlet of the internal channel 230, may have a different length from that of the other curved portion T1 formed near the inlet of the internal channel 230. This facilitates the cell scattering into single cells.

The second inkjet head 220 discharges the single cells 140 onto the cell fixing material 120 in the form of droplets along with the cell scattering materials 130. The cell scattering materials 130 are combined with the cell fixing materials 120 while the single cells 140 are fixed by the cell fixing materials 120, respectively.

Furthermore, the outlet of the internal channel 230 may be provided with a single cell detection module. The single cell detection module may include a light source 310 emitting light to a cell passing a specific location, and a detector 320 detecting a signal change in light passing through the cell. The single cell detection module may adjust the number of cells being discharged.

The internal channel 230 may have a quadrangular sectional shape as in this exemplary embodiment. However, the present invention is not limited thereto, and the internal channel 230 may have various sectional shapes, such as a triangular, pentagonal or hexagonal shape.

FIG. 3B is a schematic conceptual view illustrating an internal channel according to another exemplary embodiment of the present invention.

According to this exemplary embodiment, the internal channel 230 may have a circular sectional shape. Furthermore, according to this exemplary embodiment, the curved portions T1 and T2 may each be curved at a predetermined angle with respect to the main passage of the internal channel 230. The length of the curved portion T2 formed near the outlet of the internal channel 230 may be different from that of the curved portion T1 formed near the inlet of the internal channel 230. Accordingly, the cell separation into a single cell may be facilitated.

FIG. 3C is a schematic conceptual view illustrating an internal channel according to another exemplary embodiment of the present invention.

According to this exemplary embodiment, the cross-sectional area R2 of the internal channel 230 toward its outlet may be smaller than the cross-sectional area R1 thereof toward its inlet. The cross-section of the internal channel 230 may have a quadrangular shape as in this exemplary embodiment. The present invention is not limited thereto, and the cross-section of the internal channel 230 may have a circular shape or a polygonal shape, such as a triangle, a pentagon or a hexagon, or a circular shape.

According to the exemplary embodiments of the present invention, single cells may be individually arranged at regular intervals by the first and second inkjet heads. Furthermore, by using another inkjet head, the cell chip may be processed with a medicine. A medicine requiring the verification of its effectiveness and reliability may be dropped onto a cell chip through an inkjet head, thereby enabling efficient experimentation.

As set forth above, according to exemplary embodiments of the invention, single cells are individually patterned at regular intervals, thereby achieving an increased chip density in a cell chip. That is, a greater amount of cell samples are fixed in a cell chip with the same area. Accordingly, different diagnoses may be conducted on cells of the same kind, and the accuracy of experimental results can be improved. Also, different kinds of cells are fixed to be tested with the same medicine or to be diagnosed at the same time.

The device for manufacturing a cell chip according to the exemplary embodiments of the present invention includes the first and second inkjet heads. Accordingly, a cell chip having cells individually arranged on a substrate at regular intervals can be manufactured.

While the present invention has been shown and described in connection with the exemplary embodiments, it will be apparent to those skilled in the art that modifications and variations can be made without departing from the spirit and scope of the invention as defined by the appended claims.

What is claimed is:

1. A cell chip comprising:
a substrate on which a plurality of cell fixing materials having a predetermined area are arranged;
a plurality of single cells fixed by the plurality of cell fixing materials, respectively; and
a plurality of cell scattering materials formed of a porous material and provided in the form of droplets combined with the plurality of cell fixing materials and surrounding the single cells, respectively.

2. The cell chip of claim 1, wherein the cell fixing materials comprise at least one selected from the group consisting of polyethylene imine, polylysine, polyvinylamine, polyarylamine, fibronectin, gelatine, colagen, elastin and laminine.

3. The cell chip of claim 1, wherein the cell fixing materials comprise a gelation material allowing for the gelation of the cell scattering materials.

4. The cell chip of claim 1, wherein the cell fixing materials comprise at least one gelation material selected from the group consisting of BaCl₂, palladium acetate, N,N′-Bis(salicylidene)pentamethylenediamine and potassium phosphate.

5. The cell chip of claim 1, wherein the substrate is coated with a hydrophobic material.

6. The cell chip of claim 1, wherein the cell scattering materials are provided in the form of sol-gel, hydrogel, alginate gel, organogel or xerogel.

7. A device for manufacturing a cell chip, the device comprising:
a first inkjet head discharging a cell fixing material having a predetermined area onto a substrate; and
a second inkjet head including an internal channel having one or more curved portions, and discharging a plurality of cells, contained in a cell scattering material passing through the internal channel, as single cells to the cell fixing material.

8. The device of claim 7, wherein the curved portions are each curved at a predetermined angle with respect to a main passage of the internal channel.

9. The device of claim 7, wherein the curved portion formed toward an outlet of the internal channel has a length different from that of another curved portion formed toward an inlet of the internal channel.

10. The device of claim 7, wherein the internal channel has a polygonal or circular sectional shape.

11. The device of claim 7, wherein the internal channel includes a single cell detection module provided at an outlet thereof and including a light source emitting light to a cell passing a specific location, and a detector detecting a signal change of light passing through the cell.

12. A device for manufacturing a cell chip, the device comprising:
a first inkjet head discharging a cell fixing material having a predetermined area onto a substrate; and
a second inkjet head including an internal channel having one or more curved portions, and discharging a single cell to the cell fixing material,
wherein the internal channel has a sectional area smaller toward an outlet thereof than that toward an inlet thereof , and serve to separate a plurality of cells, included in a cell scattering material passing through the internal channel, into single cells.

13. The device of claim 12, wherein the internal channel includes a single cell detection module provided at the outlet thereof and including a light source emitting light to a cell passing a specific location, and a detector detecting a signal change of light passing through the cell.

14. A method of manufacturing a cell chip, the method comprising:
discharging, by a first inkjet head, a cell fixing material having a predetermined area on a substrate;
passing a cell scattering material, including a plurality of cells, through an internal channel having a curved portion to thereby separate the plurality of cells into single cells; and
discharging the cell scattering material and each of the single cell in the form of a droplet to the cell fixing material.

15. The method of claim 14, wherein the cell fixing material comprises a gelation material allowing for the gelation of the cell scattering material.

16. The method of claim 14, wherein the separating of the plurality of cells into single cells comprises:
emitting light to a cell passing a specific location of the internal channel; and
adjusting the number of cells by detecting a signal change of light passing through the cell.
